(19) United States
(12) Patent Application Publication
(10) Pub. No.: US 2019/0162525 A1
(43) Pub. Date: May 30, 2019

(54) INFRARED SENSOR

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YU-CHUN SUN, New Taipei (TW); ZHAN-SHENG LU, Shenzhen (CN); ZE-MIN WU, Shenzhen (CN)

(73) Assignees: Fu Tai Hua Industry (Shenzhen) Co., Ltd., Shenzhen (CN); HON HAI PRECISION INDUSTRY CO., LTD., New Taipei (TW)

(21) Appl. No.: 15/870,860

(22) Filed: Jan. 13, 2018

(30) Foreign Application Priority Data
Nov. 24, 2017 (CN) 201711194378.X

(51) Int. Cl. G01B 11/14

(52) U.S. Cl. CPC G01B 11/14

(57) ABSTRACT

An infrared sensor includes a housing, a circuit board, an infrared emitting device, and an infrared receiving device. The circuit board receives in the housing and includes an upper surface and a lower surface. The upper surface and the lower surface are opposite sides of the circuit board. The infrared emitting device is arranged on the upper surface of the circuit board and includes an emitter which is configured to emit infrared signals. The infrared receiving device is arranged on the lower surface of the circuit board and includes a receiver which configured to receive reflected infrared signals reflected by an object. The receiver is offset relative to the emitter, and the circuit board converts an infrared voltage value of the reflected infrared signals to determine a distance of the object.

### CROSS-REFERENCE TO RELATED APPLICATIONS

This application claims priority to Chinese Patent Application No. 201711194378.X filed on Nov. 24, 2017, the contents of which are incorporated by reference herein.

### FIELD

The subject matter herein generally relates to infrared sensors.

### BACKGROUND

Generally, an infrared sensor requires an emitter for emitting infrared signals and a receiver for receiving infrared signals.

### BRIEF DESCRIPTION OF THE DRAWINGS

Implementations of the present disclosure will now be described, by way of example only, with reference to the attached figures.

FIG. 1 is an exploded, isometric view of an exemplary embodiment of an infrared sensor in accordance with an embodiment of the present disclosure.

FIG. 2 is a side view of an infrared emitting device and an infrared receiving device of FIG. 1.

FIG. 3 is an assembled isometric view of the infrared sensor of FIG. 1.

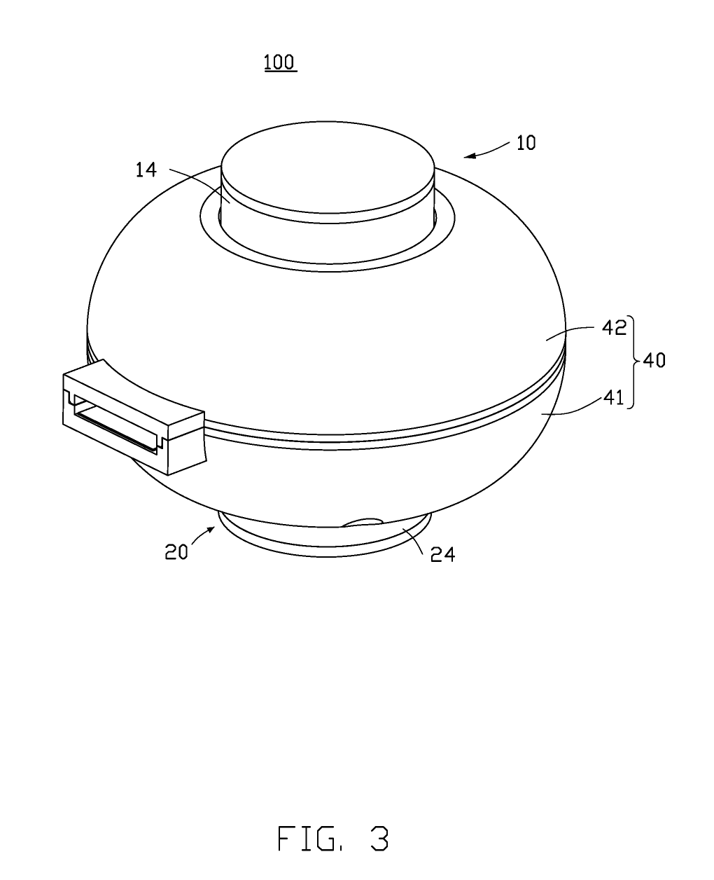

FIG. 4 is a cross-sectional view of the infrared sensor of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

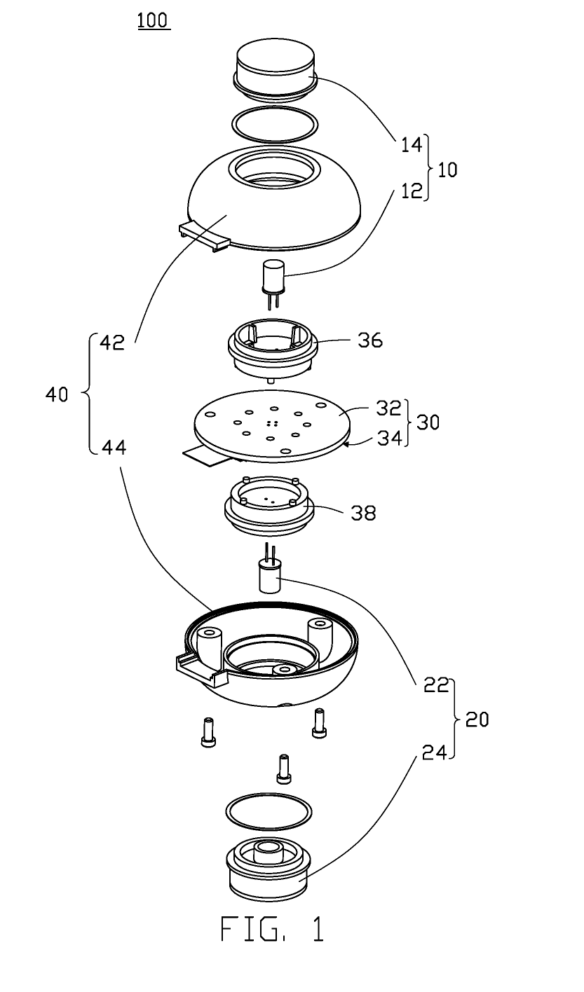

FIG. 1 illustrates an embodiment of an infrared sensor 100. The infrared sensor 100 includes an infrared emitting device 10, an infrared receiving device 20, a circuit board 30, and a housing 40. The housing 40 includes an upper housing 42 and a lower housing 44. The circuit board 30 is received within the housing 40 between the upper housing 42 and the lower housing 44 and is substantially centrally located within the housing 40. The circuit board 30 includes an upper side 32 and a lower side 34. The upper side 32 and the lower side 34 are opposite sides of the circuit board 30. The infrared emitting device 10 is arranged on the upper side 32, and the infrared receiving device 20 is arranged on the lower side 34. The upper housing 42 arranged on the upper surface 32 of the circuit board 30 surrounds the infrared emitting device 10. The lower housing 44 arranged on the lower surface 34 of the circuit board 30 surrounds the infrared receiving device 20.

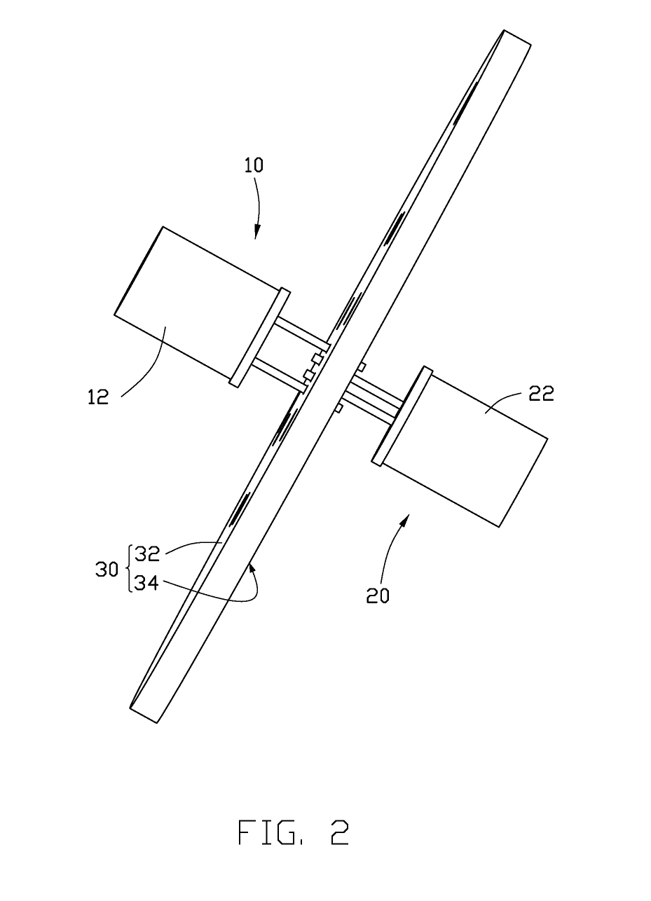

Referring to FIG. 2, the infrared emitting device 10 includes an emitter 12 arranged on the upper surface 32 of the circuit board 30. The infrared receiving device 20 includes a receiver 22 arranged on the lower surface 34 of the circuit board 30. The receiver 22 is offset relative to the emitter 12. In at least one embodiment, the emitter 12 and the receiver 22 are arranged along a common axis, and the receiver 22 is offset 90 degrees relative to the emitter 12. The infrared emitting device 10 includes an emission lens 14 arranged on a top portion of the upper cover 42. The emission lens 14 is a parabolic mirrored optical lens and surrounds the emitter 12. The emission lens 14 is made of transparent polycarbonate. When the emitter 12 emits infrared signals, the infrared signals are emitter to the emission lens 14, and the emission lens 14 reflects and disperses the infrared signals. Thus, the infrared signals can be emitted in multiple directions. Similarly, the infrared receiving device 20 includes a receiving lens 24 arranged on a bottom portion of the lower cover 44. The receiving lens 24 is a parabolic mirrored optical lens and surrounds the receiver 22. The receiving lens 24 is made of polycarbonate and is used for receiving reflected infrared signals and focusing the reflected infrared signals on the receiver 22. The receiving lens 24 arranged on the bottom portion of the lower cover 44 allows the receiving lens 24 to receive reflected infrared signals from multiple directions.

The circuit board 30 includes an upper socket 36 and a lower socket 38. The upper socket 36 is arranged centrally on the upper surface 32. The upper socket 36 is used for installing the emitter 12. The lower socket 38 is arranged centrally on the lower surface 34. The lower socket 38 is used for installing the receiver 22. The infrared sensor 100 is assembled by the upper socket 36 and the lower socket 38 installing the emitter 12 and the receiver 22, respectively, and then assembling the upper cover 42 and the lower cover 44 on the circuit board. The infrared emitting device 10 is arranged within the upper cover 42, and the infrared receiving device 20 is arranged within the lower cover 44. The emission lens 14 and the receiving lens 24 allow the infrared sensor 100 to emit infrared signals in multiple directions and detect an object from multiple directions, thereby unifying the emitter 12 and the receiver 22 in one infrared sensor 100. Thus, the emitter 12 and the receiver 22 do not belong to separate devices.

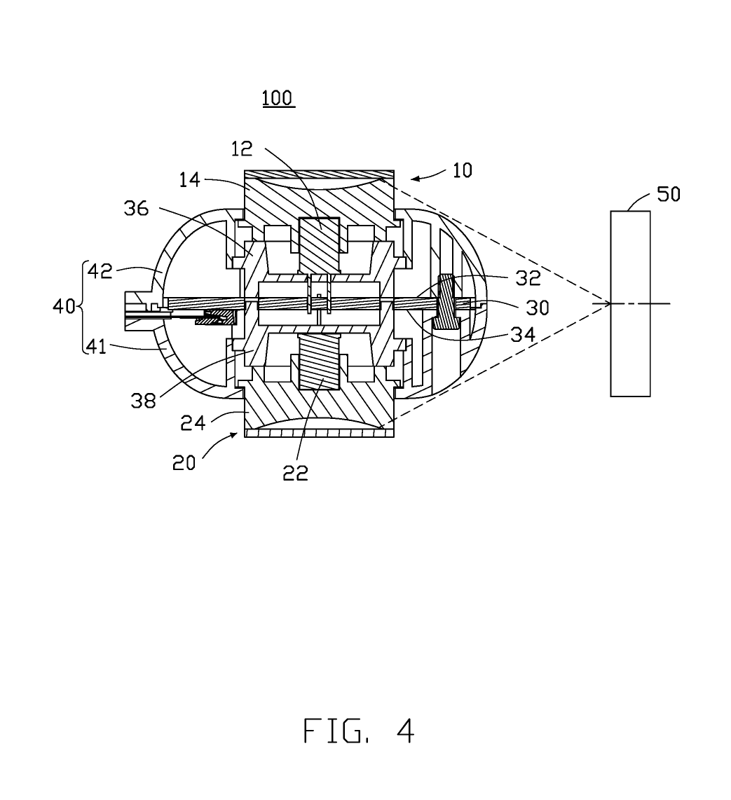

Referring to FIG. 4, the upper cover 42 and the lower cover 44 are assembled together to form the housing 40. The circuit board 30 is received within the housing 40. The emitter 12 is installed in the upper socket 36 arranged on the upper surface 32 of the circuit board 30. The receiver 22 is installed in the lower socket 38 arranged on the lower surface 34 of the circuit board 30. The emitter 12 and the receiver 22 are arranged along a common axis. The emission lens 14 surrounds the emitter 12 and reflects and disperses the infrared signals in multiple direction, thereby increasing a detection area. When the infrared signals reach an object 40, the infrared signals are reflected and received by the receiving lens 24. The receiving lens 24 focuses the reflected infrared signals on the receiver 22. The circuit board 30 includes electronic components (not shown) for processing the received infrared signals and converts an infrared voltage value to calculate a distance of the object 50. A method of converting the infrared voltage value is known in the art, so it will not be further described.

The infrared sensor 100 including the housing 40, the circuit board 30, the infrared emitting device 10, and the infrared receiving device 20 can detect objects in multiple directions. The emitter 12 and the receiver 22 are arranged along a common axis and offset on the circuit board 30 simplifies distance sensing and 3D modeling calculations.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An infrared sensor comprising:
a housing;
a circuit board receiving in the housing and comprising an upper surface and a lower surface, wherein the upper surface and the lower surface are opposite sides of the circuit board;
an infrared emitting device arranged on the upper surface of the circuit board and comprising an emitter configured to emit infrared signals; and
an infrared receiving device arranged on the lower surface of the circuit board and comprising a receiver configured to receive reflected infrared signals reflected by an object;
wherein the receiver is offset relative to the emitter; and
wherein the circuit board converts an infrared voltage value of the reflected infrared signals to determine a distance of the object.

2. The infrared sensor of claim 1, wherein the infrared emitting device comprises an emission lens arranged on a top surface of the housing; the emission lens is a parabolic mirrored optical lens surrounding the emitter.

3. The infrared sensor of claim 2, wherein the emission lens is made of transparent polycarbonate; infrared signals emitted to the emission lens by the emitter are reflected and dispersed.

4. The infrared sensor of claim 1, wherein the infrared receiving device comprises a receiving lens arranged on a bottom surface of the housing; the receiving lens is a parabolic mirrored optical lens surrounding the receiver.

5. The infrared sensor of claim 4, wherein the receiving lens is made of transparent polycarbonate; the receiving lens focuses the reflected infrared signals on the receiver.

6. The infrared sensor of claim 1, wherein the housing comprises an upper cover and a lower cover; the circuit board is arranged between the upper cover and the lower cover; the upper cover is arranged on the upper surface of the circuit board and surrounds the infrared emitting device; the lower cover is arranged on the lower surface of the circuit board and surrounds the infrared receiving device.

7. The infrared sensor of claim 6, wherein the emission lens is arranged on a top of the upper cover; the receiving lens is arranged on a bottom of the lower cover.

8. The infrared sensor of claim 6, wherein the circuit board comprises an upper socket arranged centrally on the upper surface; the emitter is installed in the upper socket.

9. The infrared sensor of claim 6, wherein the circuit board comprises a lower socket arranged centrally on the lower surface; the receiver is installed in the lower socket.

10. The infrared sensor of claim 1, wherein the emitter and the receiver are arranged along a common axis; the receiver is offset 90 degrees relative to the emitter.
